(19) United States
(12) Patent Application Publication
(10) Pub. No.: US 2006/0085170 A1
(43) Pub. Date: Apr. 20, 2006

(54) Method and apparatus for modeling and analyzing light

(76) Inventors: Daniel C. Glaser, Troy, NY (US); Jan Voung, Sacramento, CA (US); Ling Xiao, Stanford, CT (US)

Correspondence Address: PILLSBURY WINTHROP SHAW PITTMAN LLP, P.O. BOX 10500, MCLEAN, VA, 22102, US

(21) Appl. No.: 11/202,948

(22) Filed: Aug. 11, 2005

Related U.S. Application Data
(60) Provisional application No. 60/600,887, filed on Aug. 11, 2004.

(51) Int. Cl. G06F 17/50

(52) U.S. Cl. 703/1

(57) ABSTRACT

Described is a modeling and analysis design environment allowing the specification of an architectural lighting system, composed of both natural and artificial lighting elements and lighting controls. The modeling environment allows users to create 3D models through a series of plan and section drawings. Its glyph language also provides for quick specification of elements such as windows, luminaires, and control systems. The analysis workbench provides both visual and robust way of analyzing multidimensional data, characteristic of lighting simulation. One aspect of the invention is a method for evaluating combinations of artificial and natural lighting to optimize lighting quality and energy cost. This method includes using integrated Plan/Section approach for specification of 3D lighting models, glyph language for quick specification of geometry in Plan/Section, a calculation manager, and visual, spreadsheet-like language for managing spatial and temporal data.

### CLAIM OF PRIORITY

This application claims the benefit of priority to U.S. Provisional Application Ser. No. 60/600,887 filed Aug. 11, 2004, which is incorporated by reference herein.

### FIELD OF THE INVENTION

This invention relates to three dimensional modeling and analysis of multidimensional data performance data.

### BACKGROUND OF THE INVENTION

For over a century, architects, engineers, and designers have understood the importance of lighting simulation as offering a wealth of information about visual and environmental performance of a building before construction. Through simulation, they are able to avoid costly repairs, inefficient operations, and occupant discomfort. Instrumental to achieving a good building, professionals require quick, iterative design tools for their own analysis as well as for communication with others. However, a major obstacle to this is that lighting simulation is a complex multidimensional problem with site (e.g., orientation, latitude, season), design (e.g., shape of building, window glazing, lamps), and occupancy (schedules, controls, visual quality) variables that existing products and tools do not manage well. Tools that support lighting design and analysis have made trade-offs between usability and accuracy. Early schematic design tools allow for professionals to rapidly look through a number of design variables, but without showing them important aspects of the lighting model. At the other extreme are tools that model major variables of light, but are extremely cumbersome and inappropriate for iterative design. Hence, although lighting is consistently identified as a critical variable in building design, there are few comprehensive and usable tools for the average architect, engineer, and designer to model and analyze light. Prior art can broken into two sections, modeling and analysis.

Modeling

Physical models built to scale are easy to construct with materials like chipboard and glue, but are limited in analysis power, cumbersome to transport, and can be costly in terms of time and materials. Calibrated tables and sky chambers correct for some analysis shortcomings, but are expensive and still require tedious manual operation to get information from sensors or cameras. Further, there are no practical ways of scaling electric lighting components which are crucial components of a lighting system. Hence, although physical models are familiar to architects, they are largely impractical as analysis tools and have limited impact on the design profession today.

There are also a number of quick paper and computer methods for determining quantity, spacing, and location of lamps, but without considerations of daylight. Omitting windows, skylights, and other natural light sources simplified these calculations, at a cost of analysis accuracy. Daylight calculations were largely added as afterthoughts—for example, to insert a window into a wall with one common product, the person has to select the wall first, then select “insert” on the menu, then item, then “object”, then “window”. As described in the limitations of modelers in '279, these types of modelers are too complex for a typical professional and require intensive training sessions to learn. Nevertheless, the modeling employed in '279 requires mastery of placing, rotating, and zooming with an orbiting camera for editing. Further, the perspective drawings produced by this camera foreshorten lengths and angles making it difficult to see true length without measuring tools.

Sketching has been proposed as a way to improve upon traditional CAD modeling systems since users can assert multiple actions at once without resorting to toolbars and users have training in drawing symbols whose traditions pre-date computers. Multiple actions occur, for example, when a user draws a line, and the software recognizes that it is a wall and its size is the stroke length. Existing sketching tools such as in Jung, et al., “Light Pen: A Sketching System for Lighting Design In A 3D Virtual Environment”, CAAD Futures, 2003, April 28-30, annotate existing 3D models that first must be created in other CAD programs and only work with a greatly simplified model of light (which does not take do global illumination or model the sun, for example). Do, E., “VR Sketchpad: Create Instant 3D worlds by Sketching on a Transparent Window”, CAAD Futures 2001, Kluwer Academic, pp. 161-172, provides sketch recognition for 2D architectural plans, but does not have a roof, window, or lighting sources in its vocabulary.

Analysis

Photographs, plots and ratios are typical artifacts created by simulation programs for analysis. These representations provide static snapshots of building performance. These results are presented individually or in tabular format, yet cannot be mechanically compared, simplified, or managed in any way. For example, even the simple case of comparing two lighting performance plots to see if they present the same information requires copious operations. The user needs to visually compare tens, hundreds, thousands, or more data points one at a time to see if they represent the same quantity.

FIG. 18 illustrates a case of a static building analysis workbench as described in Papamichael, “Application of Information Technologies in Building Design Decisions”, Building Research & Information, Vol. 27, No. 1, January/February 1999, showing results for three design cases. The second row of this figure compares side by side the visual quality of the spaces throughout the year. Scale differences aside, peaks in each cell can be identified and roughly compared, but other aspects such as finding the highest average, the number of days meeting a lighting requirement, or the best January performance is difficult to ascertain from this static representation of multiple variables.

To automate this process, users would have to use third party tools such as a conventional spreadsheet, scripting language, or mathematical package. Generic spreadsheets with data in row and columns are ill-suited for storing, viewing, and analyzing architectural lighting data which varies by two or three spatial axes as well as time of day and season. 2D data subsets can be managed, but this is at a cost of missing important trends in the data. Scripting languages and mathematical packages allow symbolic manipulation of information, but require significant programming or engineering skills that are inappropriate for most people in the building industry. All these cases are further complicated since they require the user to export data from their lighting simulation program into these tools, further slowing the iterative design process.

In summary, architects, engineers, and designers do not have access to rapid modeling and analysis tools for exploring the full dimensionality of light. Existing modeling tools are either but cumbersome, or quick and of limited use. Analysis tools do not provide support for making sense of the rich, multidimensional data that is produced through simulation. Combined, these limitations make it difficult to iterate and test a number of design scenarios to optimize lighting quality for a building.

### SUMMARY OF THE INVENTION

The objects and advantages of this invention allow a person to quickly iterate through a number of modeling and analysis cycles to optimize lighting performance. Rapid modeling is achieved through stroke interpretation, drawing layers, and plan/section representation of 3D models. The analysis is simplified through an organizer that manages many design iterations, provides an infrastructure for comparing and manipulating results graphically, as well as a visualization tool.

Architectural Pens

The user is allowed to choose pens that have specific behavior for creating different types of architectural geometry. Just as there are pens with different attributes for writers and illustrators, architects need pens that can draw different types of basic geometry. The “ortho” pen, for example, allows the user to draw lines that are only horizontal or vertical. With existing CAD tools, a special command, mask, or designation is invoked when drawing a line stay on axis.

Glyphs

The invention allows users quickly can model the major elements of an architectural lighting system through glyphs. This allows designers to work with symbols familiar to them, instead of a generic 3D drawing package or finding icons for objects. If the system is incorrect, there is still a mechanism for the user to change the false interpretations.

Interpretation may begin as early as the first point of a stroke is placed, and may continue after the stroke is completed. The advantage is that feedback can be displayed while drawing. Furthermore, multiple interpretations (and hence, actions) maybe be accepted by the system. An illustration of the advantages of these two features is when a user draws a line. The software interprets that a user is drawing a wall but also interprets the stroke as a measurement of length. Both related actions are fulfilled 1) a wall is added to the model when the stroke is completed, and 2) the length of the wall is be measured and displayed to aid the user during the drawing process.

Strokes often leave much room for interpretation, but the invention will choose a reasonable interpretation. A reasonable interpretation is determined after learning a user preference, or by choosing the standard interpretation. In the wall drawing example, a user may have an unsteady hand and insert several caret-like shapes in an otherwise straight horizontal stroke. The drawn stroke may also cross a previously drawn wall by a short distance. A standard interpretation is that the perturbations are unintentional and the stroke should be modified to be straight. Furthermore, the stroke should be trimmed to meet with the existing wall. Finally, although the length of the wall is indicated by the stroke, the thickness and height are not. The system can choose standard values for those dimensions. Of course, these standard interpretations can be overridden if the system learns that the user desires more freedom (the freedom to draw perturbed walls, etc.), or learns that the user prefers other values (e.g., that most previously drawn walls have been changed by the user to be shorter). The advantage of this is that most of the time the system is correct, avoiding wasteful interaction with the user.

Drawing Layers

If all objects were in the same layer, there must be a complicated vocabulary so that interpretations do not clash. By separating the drawing canvas and associated interpreters into different layers, the vocabulary for each layer can remain simple without clashes and misinterpretation. In fact, with the use of layers, most important objects can be specified with simple lines.

Another important aspect of the invention's layers is that some are static, or system-defined. Having fixed semantics is useful for several reasons. First, it recognizes that generic 3D architecture drawing and drafting instruments do not direct provide support for creating lighting models. For most buildings, this is simply walls, ceilings, roofs, fenestration, electric lighting system, and the site terrain and obstructions. There is no need, in most cases, to use a complex tool capable of creating doorknobs, insulation materials, and a joist to model the important variables of light. Hence, users will be supported by being able to “fill-in” each significant lighting component instead of being faced with an empty slate and drawing tools.

Layers may also have attached context-specific controls. From the reflected ceiling plan layer, both the user and the system can expect it to be populated by luminaires, wires and controls. Thus the luminaire layer may be equipped with a context-specific user-interface to turn on or off all luminaires for the next simulation. Another example is that a list-based visualization of the available layers can serve as a project checklist. During use, the system may show a list of layers, all populated except for the roof layer. If the layer is empty, then the user will know that the roof must be completed before the project is considered complete.

Inside Layer

The inside layer defines the sidelighting of a building. Namely this is where walls, windows, and shelves are entered.

Outside Layer

In this layer a user can quickly draw trees and nearby obstructions. Both these can be major factors affecting lighting quality and energy consumption. For example, if a building's site is next to a fifteen story condominium, a single stroke outside can represent this facade.

Roof Layer

The invention allows an architect to draw their roof in plan (which allows architects to see its overhang, for example, with respect to the exterior walls) and shape it like elastic film. Once drawn in plan, a beam can be inserted into the elastic and lifted. The insertion and lifting allows a range of roof types including gable, hipped, or sloped. Further, multiple beams forming a rectangle (or other shapes) can be inserted to lift a plane of the elastic, creating such features such as a dormer, saw-tooth, and monitor. In section, beams can also be inserted and the roof defined.

Glyph recognition also simplifies this construction process. Namely if the user does not want to insert beams in plan, revise in section, and add details, they can use symbol shorthand. A dormer can be created by drawing its glyph in section on the roof. This creates the necessary beams, stretches, and windows for a basic dormer.

Reflected Ceiling Plan Layer

The Reflected Ceiling Plan (RCP) layer allows users to draw luminaires, wires for banking, and controls quickly and with great flexibility. For example, an engineer can draw wires connecting select luminaires to a standard photosensor control. This allows the watt watcher and other stanzas to observe the dimming of these lights throughout the day. Since the amount of lighting hardware exceeds available glyph types, glyphs can be further subspecified through their property box.

Stanza Layer

Stanza layers are where simulations are defined. We use the term “stanza” to describe any type of simulation such as a camera, sensor grid, or watt watcher. Many stanzas can populate drawings.

Image Layer

This is where background images can be stored as drawing reference aids.

Plan/Section

The invention provides a plan/section approach to modeling 3D geometry. This approach allows users to work in plan and section exclusively to draw 3D lighting models, without getting into disorienting perspective. It relies on the fact that when specifying X, Y dimensions in plan, system or user defined default Z coordinates can be chosen. If the Z coordinate is not correct, the section tool can cut through the object in plan and create a section showing its start and endpoints in Z. The user can quickly modify its Z dimension with a stroke.

Site Variables

The site variables can be set quickly by the user. Changing the sky condition, for example, requires toggling through a button. Changing the North Arrow by dragging it changes the building's orientation.

Stanza Creator

After the user creates perspectives, illuminance grids, watt watchers and other simulation results (stanzas), the stanza creator summarizes what the user has done and allows for on the spot changes. For example, a user may decide to temporarily “turn off” one stanza or change the quality setting of another.

Stanza Organizer

After simulations (stanzas) are run, they need to be stored somewhere. The stanza organizer keeps track of these results just like a graphical file system that is already familiar to users. This allows people to manage many results at once, and see results as icons or detailed lists of simulation results (stanzas). In addition to holding user-generated data, it can manage information that is hard-coded like building code standards, electricity rates, or occupancy schedules.

Simulation Calculator

Seeing building results is not enough for designers to assess if one design is better than another, if a building meets a green-building code, or just investigating a single dataset. The calculator provides infrastructure to manage the most frequent operations a user may request. For example, for green buildings, a user may be required to see if 75% of a space meets a 2 df minimum. With the calculator, the user can compare a simulation result (stanza) with 2 df standard. Each point in the stanza can be assigned a value of 1 (true) or 0 (false). If these numbers are averaged and the result is greater than 75%, then the code is met. In addition to having operators, the calculator

Stanza Viewer

The simulation viewer shows a simulation result (stanza) up close and allows for further manipulations of the Stanza. The viewer shows the stanza, allows for standard focusing on data, as well as calculation capabilities for between stanzas.

### BRIEF DESCRIPTION OF THE DRAWINGS

The present invention is illustrated by way of example, and not by way of limitation, in the figures of the accompanying drawings and in which like reference numbers refer to similar elements and in which:

FIG. 1. Abstract system and user-interfacec modules

FIG. 2. The components for the sketch modeler

FIGS. 3A-3D. Architectural Pens

FIGS. 4A-4D Glyph recognition

FIGS. 5A-5D. Layers

FIGS. 6A-6G Glyph vocabulary

FIGS. 7A-7F Section tool (add window here)

FIGS. 8A-8L Roof layer and ridge tool

FIGS. 9A-9D Site orientation

FIGS. 10A-10D Stanza Organizer

FIGS. 11A-11K Stanza Calculator

FIGS. 12A-12D Stanza Viewer

FIGS. 13A-13D Analysis engine

FIG. 14 Colormap

FIG. 15 Plan and Section view Screenshot

FIG. 18 Screenshot of traditional analysis tool

### DETAILED DESCRIPTION

The objects and advantages of this invention allow a person to quickly iterate through a number of modeling and analysis cycles to optimize lighting performance. Rapid modeling is achieved through stroke interpretation, drawing layers, and plan/section representation of 3D models. The analysis is simplified through an organizer that manages many design iterations, provides an infrastructure for comparing and manipulating results graphically, as well as a visualization tool.

Architectural Pens

The user is allowed to choose pens that have specific behavior for creating different types of architectural geometry. Just as there are pens with different attributes for writers and illustrators, architects need pens that can draw different types of basic geometry. The “ortho” pen, for example, allows the user to draw lines that are only horizontal or vertical. With existing CAD tools, a special command, mask, or designation is invoked when drawing a line stay on axis.

Glypths

The invention allows users quickly can model the major elements of an architectural lighting system through glyphs. This allows designers to work with symbols familiar to them, instead of a generic 3D drawing package or finding icons for objects. If the system is incorrect, there is still a mechanism for the user to change the false interpretations.

Interpretation may begin as early as the first point of a stroke is placed, and may continue after the stroke is completed. The advantage is that feedback can be displayed while drawing. Furthermore, multiple interpretations (and hence, actions) maybe be accepted by the system. An illustration of the advantages of these two features is when a user draws a line. The software interprets that a user is drawing a wall but also interprets the stroke as a measurement of length. Both related actions are fulfilled 1) a wall is added to the model when the stroke is completed, and 2) the length of the wall is be measured and displayed to aid the user during the drawing process.

Strokes often leave much room for interpretation, but the invention will choose a reasonable interpretation. A reasonable interpretation is determined after learning a user preference, or by choosing the standard interpretation. In the wall drawing example, a user may have an unsteady hand and insert several caret-like shapes in an otherwise straight horizontal stroke. The drawn stroke may also cross a previously drawn wall by a short distance. A standard interpretation is that the perturbations are unintentional and the stroke should be modified to be straight. Furthermore, the stroke should be trimmed to meet with the existing wall. Finally, although the length of the wall is indicated by the stroke, the thickness and height are not. The system can choose standard values for those dimensions. Of course, these standard interpretations can be overridden if the system learns that the user desires more freedom (the freedom to draw perturbed walls, etc.), or learns that the user prefers other values (e.g., that most previously drawn walls have been changed by the user to be shorter). The advantage of this is that most of the time the system is correct, avoiding wasteful interaction with the user.

Drawing Layers

If all objects were in the same layer, there must be a complicated vocabulary so that interpretations do not clash. By separating the drawing canvas and associated interpreters into different layers, the vocabulary for each layer can remain simple without clashes and misinterpretation. In fact, with the use of layers, most important objects can be specified with simple lines.

Another important aspect of the invention's layers is that some are static, or system-defined. Having fixed semantics is useful for several reasons. First, it recognizes that generic 3D architecture drawing and drafting instruments do not direct provide support for creating lighting models. For most buildings, this is simply walls, ceilings, roofs, fenestration, electric lighting system, and the site terrain and obstructions. There is no need, in most cases, to use a complex tool capable of creating doorknobs, insulation materials, and a joist to model the important variables of light. Hence, users will be supported by being able to “fill-in” each significant lighting component instead of being faced with an empty slate and drawing tools.

Layers may also have attached context-specific controls. From the reflected ceiling plan layer, both the user and the system can expect it to be populated by luminaires, wires and controls. Thus the luminaire layer may be equipped with a context-specific user-interface to turn on or off all luminaires for the next simulation. Another example is that a list-based visualization of the available layers can serve as a project checklist. During use, the system may show a list of layers, all populated except for the roof layer. If the layer is empty, then the user will know that the roof must be completed before the project is considered complete.

Inside Layer

The inside layer defines the sidelighting of a building. Namely this is where walls, windows, and shelves are entered.

Outside Layer

In this layer a user can quickly draw trees and nearby obstructions. Both these can be major factors affecting lighting quality and energy consumption. For example, if a building's site is next to a fifteen story condominium, a single stroke outside can represent this facade.

Roof Layer

The invention allows an architect to draw their roof in plan (which allows architects to see its overhang, for example, with respect to the exterior walls) and shape it like elastic film. Once drawn in plan, a beam can be inserted into the elastic and lifted. The insertion and lifting allows a range of roof types including gable, hipped, or sloped. Further, multiple beams forming a rectangle (or other shapes) can be inserted to lift a plane of the elastic, creating such features such as a dormer, saw-tooth, and monitor. In section, beams can also be inserted and the roof defined.

Glyph recognition also simplifies this construction process. Namely if the user does not want to insert beams in plan, revise in section, and add details, they can use symbol shorthand. A dormer can be created by drawing its glyph in section on the roof. This creates the necessary beams, stretches, and windows for a basic dormer.

Reflected Ceiling Plan Layer

The Reflected Ceiling Plan (RCP) layer allows users to draw luminaires, wires for banking, and controls quickly and with great flexibility. For example, an engineer can draw wires connecting select luminaires to a standard photosensor control. This allows the watt watcher and other stanzas to observe the dimming of these lights throughout the day. Since the amount of lighting hardware exceeds available glyph types, glyphs can be further subspecified through their property box.

Stanza Layer

Stanza layers are where simulations are defined. We use the term “stanza” to describe any type of simulation such as a camera, sensor grid, or watt watcher. Many stanzas can populate drawings.

Image Layer

This is where background images can be stored as drawing reference aids.

Plan/Section

The invention provides a plan/section approach to modeling 3D geometry. This approach allows users to work in plan and section exclusively to draw 3D lighting models, without getting into disorienting perspective. It relies on the fact that when specifying X, Y dimensions in plan, system or user defined default Z coordinates can be chosen. If the Z coordinate is not correct, the section tool can cut through the object in plan and create a section showing its start and endpoints in Z. The user can quickly modify its Z dimension with a stroke.

Site Variables

The site variables can be set quickly by the user. Changing the sky condition, for example, requires toggling through a button. Changing the North Arrow by dragging it changes the building's orientation.

Stanza Creator

After the user creates perspectives, illuminance grids, watt watchers and other simulation results (stanzas), the stanza creator summarizes what the user has done and allows for on the spot changes. For example, a user may decide to temporarily “turn off” one stanza or change the quality setting of another.

Stanza Organizer

After simulations (stanzas) are run, they need to be stored somewhere. The stanza organizer keeps track of these results just like a graphical file system that is already familiar to users. This allows people to manage many results at once, and see results as icons or detailed lists of simulation results (stanzas). In addition to holding user-generated data, it can manage information that is hard-coded like building code standards, electricity rates, or occupancy schedules.

Simulation Calculator

Seeing building results is, not enough for designers to assess if one design is better than another, if a building meets a green-building code, or just investigating a single dataset. The calculator provides infrastructure to manage the most frequent operations a user may request. For example, for green buildings, a user may be required to see if 75% of a space meets a 2 df minimum. With the calculator, the user can compare a simulation result (stanza) with 2 df standard. Each point in the stanza can be assigned a value of 1 (true) or 0 (false). If these numbers are averaged and the result is greater than 75%, then the code is met. In addition to having operators, the calculator

Stanza Viewer

The simulation viewer shows a simulation result (stanza) up close and allows for further manipulations of the Stanza. The viewer shows the stanza, allows for standard focusing on data, as well as calculation capabilities for between stanzas.

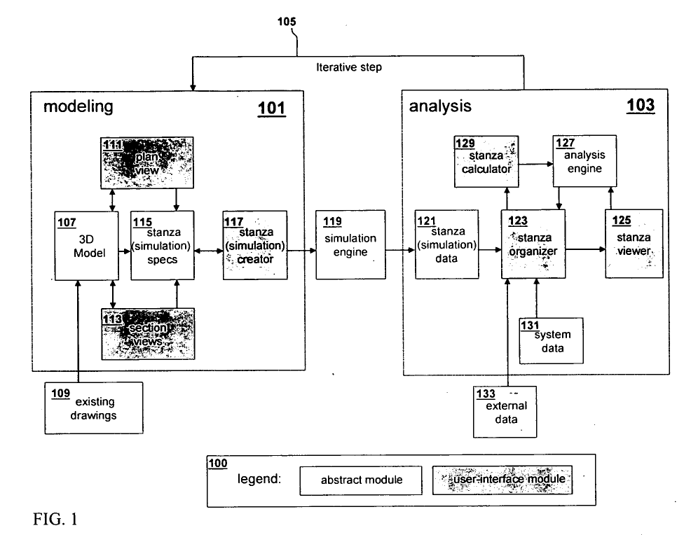

FIG. 1 illustrates the abstract and user interface modules 100 of the tool. 101 and 103 show the modeling and analysis processes, respectively. 105 highlights the iterative nature of the entire process of the whole.

The modeling module 101 begins with plan 111 and section 113 views, or the importation of an existing (CAD) drawing 109. As a result, the 3D model is created, which can be further modified through plan and section view. Stanza specifications 115 define simulation type and parameters, such as setting up a camera for a photograph or defining grid-points for illuminance readings. Information is passed to the simulation engine 119 by the stanza creator 117. The stanza creator allows the user to review stanza requests, before simulation, facilitating last-minute changes. This is important as sometimes the user is no longer interested in a particular viewpoint chosen, or they would like to change time parameters without having to revise the plan or section drawings.

The analysis module 103 manages a variety of data. First, it stores the multidimensional data that can be of a variety of types produced by the simulation engine 121. The stanza data is then added to the stanza organizer 123 for inspection and comparison by the user. Here, the user can both get a closer look of the stanza through the viewer 125, or he or she can drop it in the calculator 129 for analysis.

Both the viewer and calculator have analysis capabilities 127 which can simplify the data, perform comparisons, or conduct other algebraic, boolean, and statistical functions. The analysis engine is wrapped in appropriate user-interfaces in the stanza calculator and stanza viewer. Further, the analysis module has built in stanzas 131 that allow the user to quickly import building standards, or other relevant data that is not directly simulated for. Finally, data collected from external sources 133, such as from data loggers in buildings can be imported into the organizer.

System Architecture for Sketch Modeler

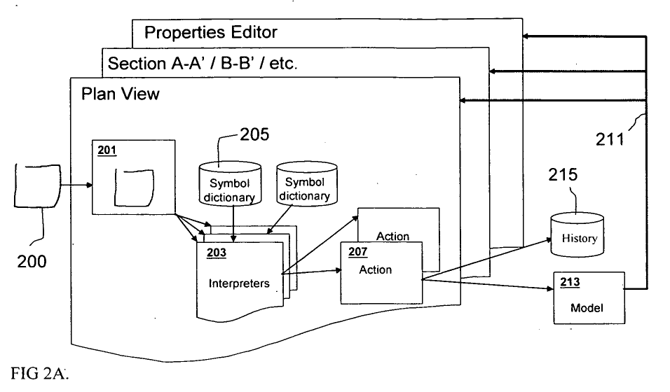

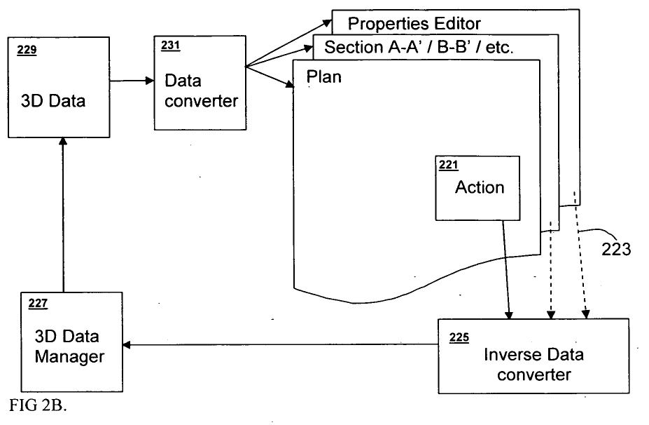

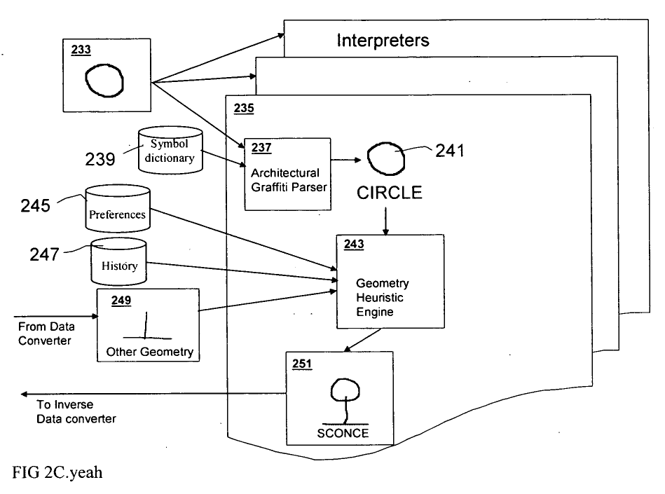

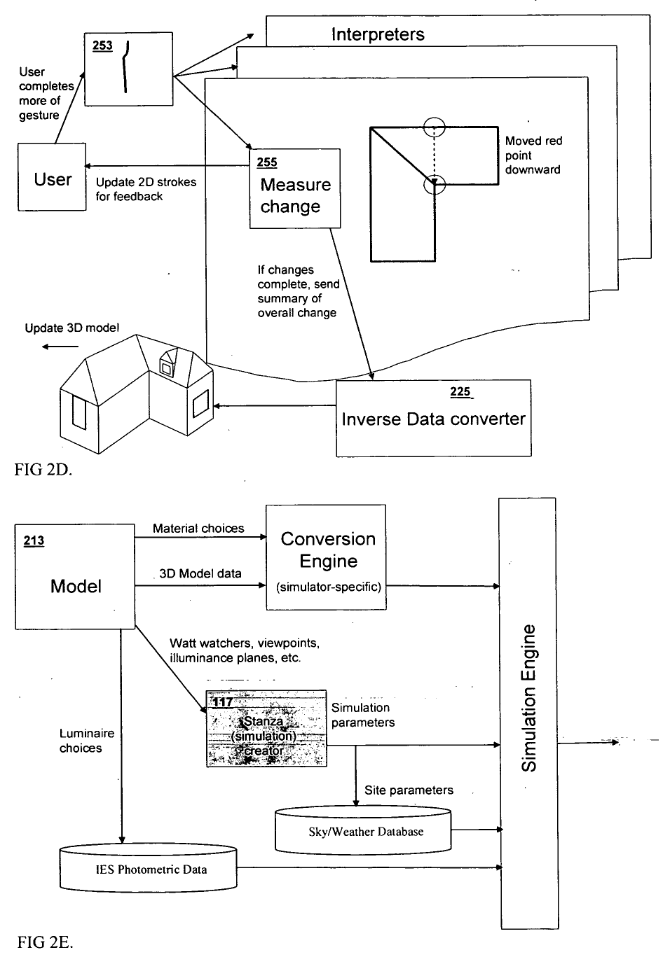

FIG. 2A shows the main components in the architecture of the sketcher. First, the user draws a box-shaped object 200. The system converts the object into distinct strokes 201. Strokes are drawn in a particular view. Here, it is the Plan View. Each view also has a set of layers. For example, there is a Roof, reflected ceiling plan (RCP), Inside, and Outside layer. Given a stroke, it must be interpreted. Each view and layer has its own set of interpreters 203. The interpreters will try to determine if the user is making a gesture (like selecting an object or moving an object) or drawing geometry. Some interpreters are backed by modules like symbol dictionaries 205. The results of an interpreter are actions 207. Actions 207 are flexible. It can be the addition of a new object, object selection, object modification, or it can be a request for information. The most common actions modify the architectural model 213. These actions are tracked in the history data structures 215 to enable undo/redo of actions, as well as to learn user preferences. Finally, a modification of the model in one view, will force update in all related views 211.

FIG. 2B elaborates on how the model 213 is be modified by an action such as 221. Although the model is three-dimensional, computer input devices and views are restricted to two dimensions. To bridge this gap, the inverse data converter 225 is used to map two-dimensional data to three dimensions. How this is done depends heavily on the characteristics of the current view. In this diagram, the action originates from the plan view. Of course, the other views 223 have interpreters and can initiate actions as well. Once the action is converted to dimensions, the action cannot be blindly applied. Sometimes, invariants must be maintained. For example, if a wall with windows is moved, the windows should stay with the wall. Maintaining these invariants is the job of the 3D Data Manager 227. It determines a more complete set of actions. Once the final actions are determined, the modifications can be made to the actual data structures 229. Finally, the views must be updated 211. The 3D data is projected back into two dimensions by the Data Converter 231 for display.

FIG. 2C shows all the parameters involved in the glyph recognition process. First, there is the stroke 233 and the set of interpreters. Each drawing layer has a glyph interpreter. The one shown 235 is the reflected ceiling plan (RCP) layer's glyph interpreter. The first step is to classify the symbol. The layer-independent graffiti parser 237 uses a symbol dictionary 239 to perform this task. Once the symbol is classified, context is examined.

Context is summarized by the history 247 of other strokes, geometry 249, and user-specified preferences 245. The stroke, classification, and context are given to the geometry heuristic engine 243 to determine that a new object is formed. In this example, a circle 241 (classification) adjacent to a T-shape 249 (classification) while in the reflected ceiling plan layer (context) equates to a sconce light 251. The position of the sconce can be determined by the strokes in plan view, but the height must be inferred. User preferences 245 and history 247 can be used to determine the height.

The results of the glyph interpreter are actions representing the addition of a sconce 251, and the subtraction of the elements previously represented by the T formation 249. As described before, these actions are passed to the inverse data converter as the next stage.

FIG. 2D illustrates how other interpreters may accept user strokes. In this figure, the interpreter is responsible for accepting editing gestures. In contrast to adding an object, the interpreter begins taking effect during the creation of the stroke to supply feedback to the user. As before, relevant data contained in the user's 2D stroke is sent to the inverse data converter 225 to update the 3D model.

FIG. 2E illustrates the simulation process. After a model is built, a user may wish to run simulations. Mainly, parameters required by the Radiance simulation engine (or any other physics-based, global illumination engine) are gathered from the system's data structures.

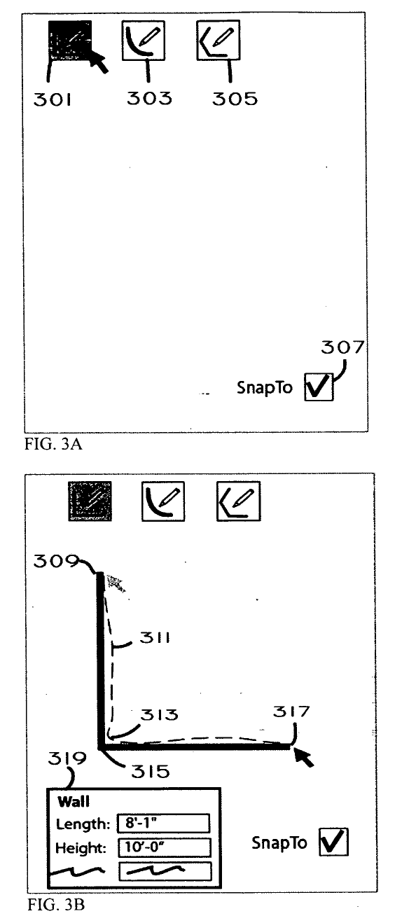

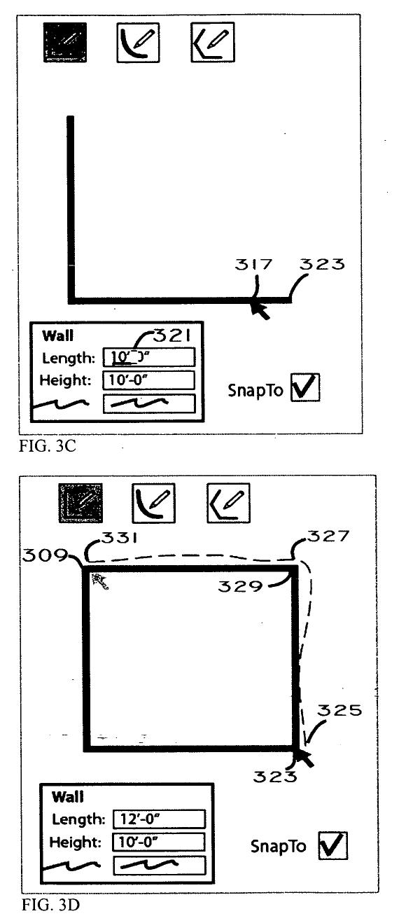

FIG. 3A. illustrates the use of the “ortho” pen. The ortho pen 301, is one of three pens, each suited for different situations. The other two are the freeform pen 303 and the moderate pen 305. The figure also shows the Snap To 307 selected. This function allows the user to snap to the endpoints of previously drawn objects and allows the system to automatically connect them.

FIG. 3B: Using the ortho pen, the user draws a stroke from point 309 to 317 through points 311 and 313. Once completed, the system attempts to make linear the stroke in three phases.

The first phase identifies distinct segments. This is done by increasing divisions to see if a more complex model gives a significant enough improvement in terms of fit. The first model is a straight line from 309 to 317, (although higher order curves can be used instead of lines). This is compared to a model with two lines: one from 309 to 313 and another from 313 to 317. The algorithm determines that two line segments is significantly better than one. Next it checks if dividing the line from 309 to 313 is significantly better. it compares the line from 309 to 313 to the two lines formed from 309 to 311 and 311 to 313. The two lines are not a significantly better fit so no further division is tested. The same comparisons occur for the segment from 313 to 317 and the system determines that 313 to 317 is sufficient.

Once the stroke has been divided into lines (and/or curves), the second phase begins. For the second phase, the ortho pen mechanism will force the segments to be completely horizontal or vertical, whichever is closer, “cleaning” the stroke. This results in line segments from 309 to 315 and 315 to 317.

The third phase is the merging phase. If, in the process of forcing lines to be vertical or horizontal, sequential segments are parallel, the sequential segments will be merged to simplify the model. No changes are made by the third phase in this example.

Once the stroke has been cleaned, the system interprets the two resulting lines as walls. By default the system focuses on the last drawn wall, in this case the wall from point 315 to 317, and displays its properties in the property display area 319. The length reads 8′-1″.

FIG. 3C: The user can enter a new length (10′-10″) in textbox 319. As a result, the endpoint 317 of the wall is moved to point 321, extending the wall 1′-11″ to 10′-0″.

FIG. 3D: Finally, the user can complete the building with stroke 327 which also under goes segmentation and cleanup. However, because the snap-to option is chosen, the segment endpoints 325 and 331 are coaxed to attach to existing endpoints, 317 and 309, respectively. This results in two different walls, with the second highlighted in the properties display area 319.

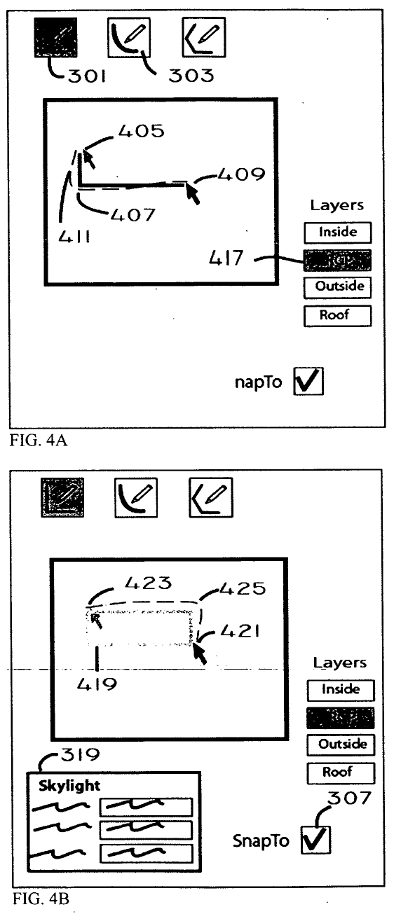

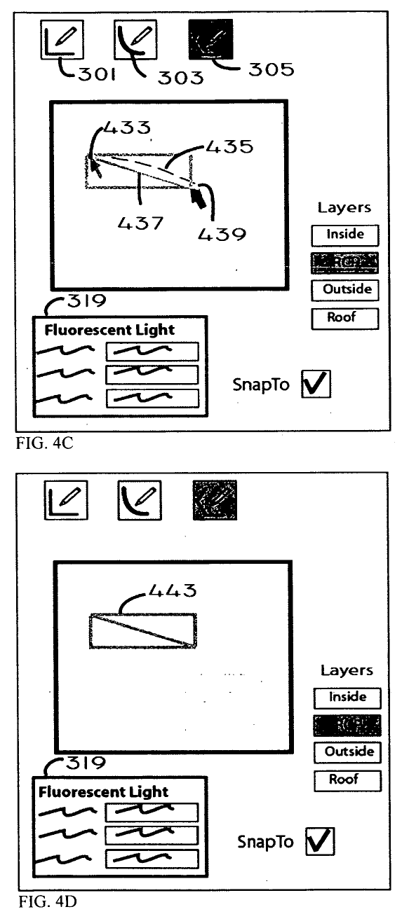

FIG. 4A illustrates the process of drawing the skylight glyph. Since a skylight is a part of the reflected ceiling plan (RCP) layer, the user must select the RCP layer 417. A skylight glyph is a rectangle. To simplify the task of drawing a clean rectangle, the user opts to use the “ortho” pen 301. The user is able to draw with one stroke, from 405 to 407 to 409. The system understands this L shaped stroke as 2 lines at a 90 degree angle to each other, the first line between 405 and 407, the second line between 407 to 409. Under properties 319, the length 321 is updated and reflects the dimension of the last line drawn in any one direction, in this case the line from 407 to 409. The length reads 4′-0″.

FIG. 4B: The user completes the rectangle by drawing another L shaped stroke 425 from points 421 to 423. Again, the ortho pen cleans the stroke. Since the Snap To 307 option is selected, the endpoints of the L shaped stroke are automatically connected to the endpoints of the first L shaped stroke in FIG. 4A. Once the rectangle is completed, the system recognizes this shape as a skylight and this information is provided in the properties box 319.

FIG. 4C: If the user would like to change this skylight into a fluorescent light, he begins by switching to the moderate pen 305 to create a diagonal line within the rectangle. The moderate pen 305 is less aggressive with stroke beautification than pen 301 (orthogonal), however more aggressive than the pen 303 (freeform). With pen 305, the user draws the diagonal stroke 435 from point 433 to 439. The system makes it linear, resulting in line 437.

FIG. 4D: Once the diagonal is complete, the system recognizes this as a fluorescent light 443 and this information is provided in the properties box 319.

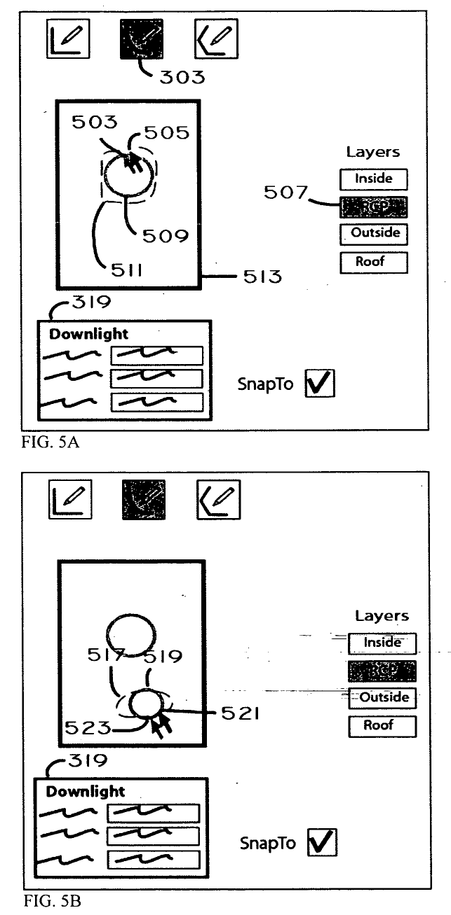

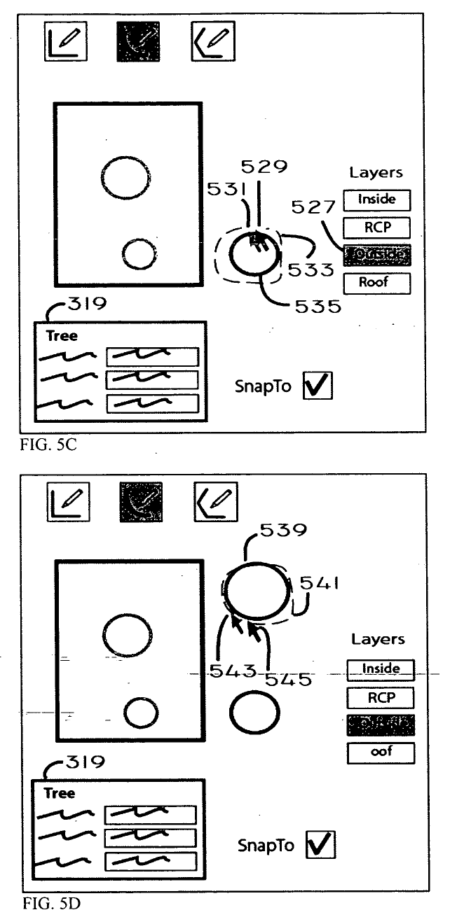

FIG. 5A: We start with a space 513, drawn using previous techniques. It is important to note, we are currently using the freeform pen 303, and we are specifying the reflected ceiling plan (RCP) layer 507 as the active context for the stroke interpreter. Thus, after we draw a rough circle starting at 503, ending at 505, and following path 511, the stroke interpreter automatically classifies it as 1) a circle; and 2) a downlight. This is the most likely interpretation given the current context is the RCP layer. The downlight classification can be seen both through the color and shape of stroke 509, as well as in the properties box 319, which is automatically updated.

FIG. 5B: We now draw another circle below the previous downlight, starting at 523, ending at 521, and following path 517. Again, the stroke interpreter correctly classifies the stroke as a downlight 519. It is important to note that although the strokes drawn by the user, 511 and 517 are completely different in terms of endpoints and path, both are recognized by the system as a downlight, demonstrating the robustness of a standard stroke interpreter to geometric transformations.

FIG. 5C: We now change the active context to be the Outside layer 527, in which the grammar recognizes a variety of common objects external to the building. We again draw a circle starting at 531, ending at 529, following path 533. The interpreter recognizes this as a tree, the most likely interpretation in the Outside layer. The system automatically makes the shape into a green circle 535, representing a tree, and updates this classification in the properties box 319.

FIG. 5D: Here we wish to draw another tree. We remain in the Outside layer and draw a circle starting at 543, ending at 545 and following path 541. The interpreter correctly identifies the stroke as a tree 539, and updates this classification in the properties box, 319. Again, note that although the user's strokes 533 and 541 were completely different in terms of endpoints and paths, the interpreter was able to recognize both strokes as trees, further demonstrating its robustness.

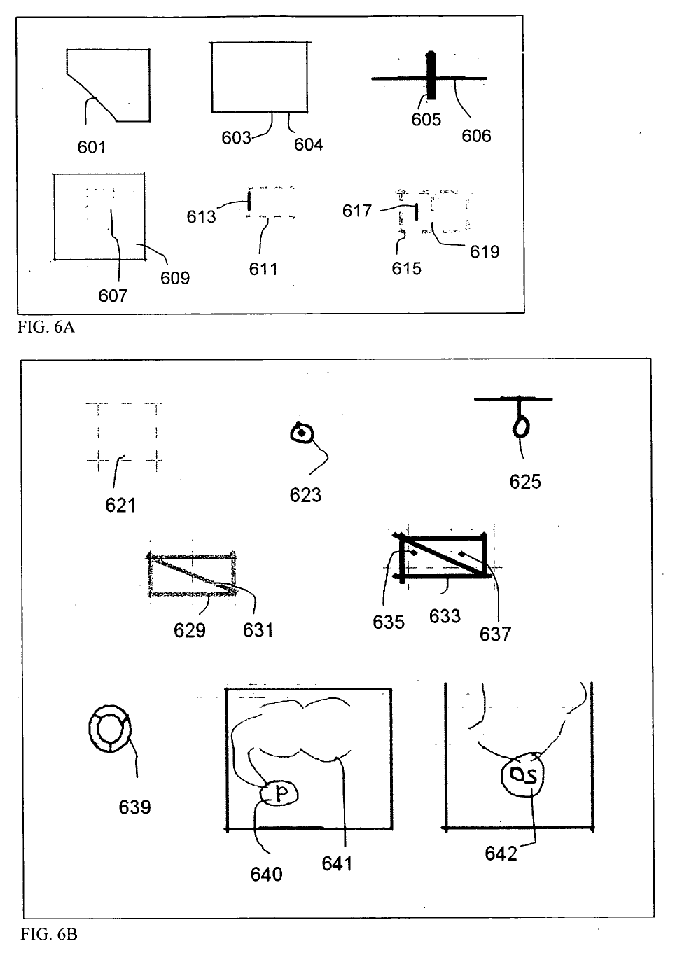

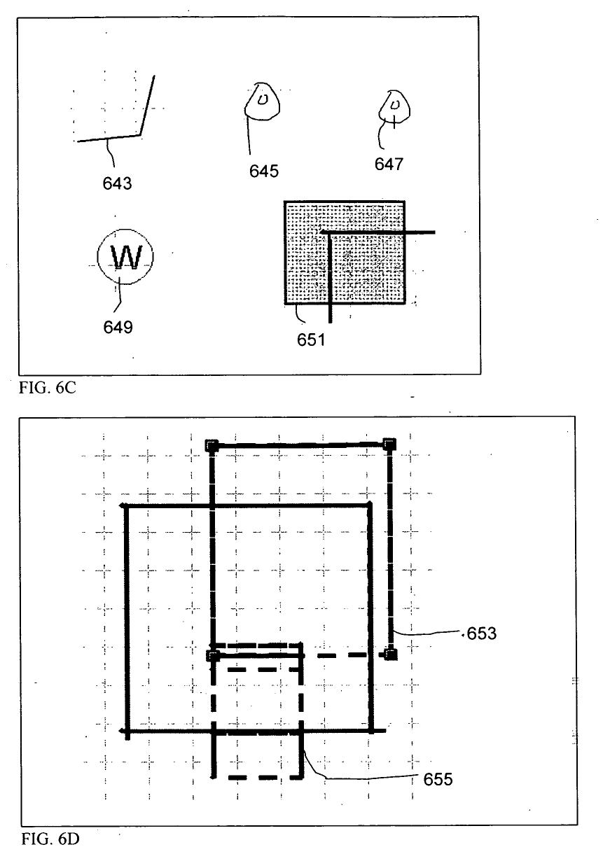

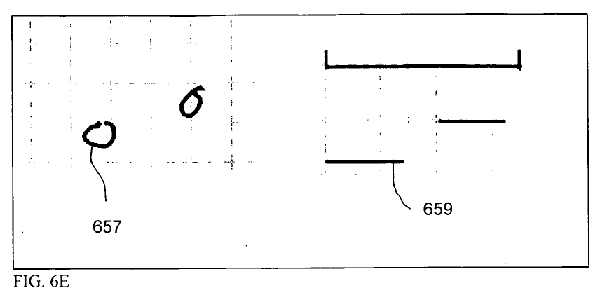

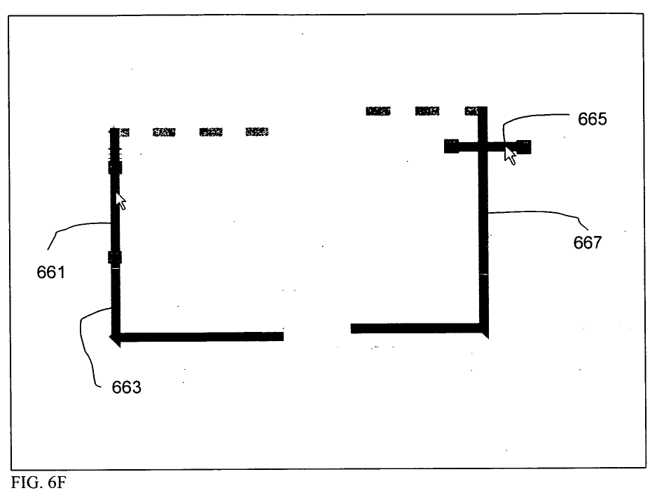

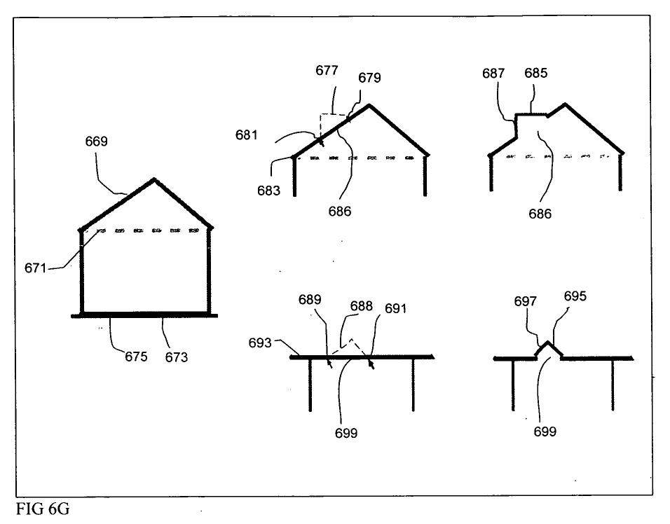

FIG. 6A Glyph symbols for plan view, Inside Layer.

601 is a wall.

603 is a window.

604 is the wall in which the window, 603 is inserted.

605 is light shelf and light shade.

606 is the window in which the light shelf and shade are located.

FIG. 6B Glyph symbols for plan view, reflected ceiling plan layer (RCP).

621 is a downlight.

623 is a pendant light.

625 is a wall sconce.

629 is fluorescent light.

633 is a suspended fluorescent light.

635 and 637 are points locations of suspension in the fluorescent light.

639 is a floor lamp.

640 is a standard photo sensor.

641 are wiring connecting downlights to the photosensor.

642 is a occupancy sensor (connected to wiring associated with downlights).

FIG. 6C: Glyph symbols for Stanzas.

643 is a viewpoint.

645 is a worm's eye view.

647 is a bird's eye view.

649 is a watcher.

651 is an illuminance grid.

FIG. 6D Glyph symbols in plan view.

653 is a flat roof.

655 is a roof with 2 ridges.

FIG. 6E: Glyph symbols in plan view, Outside layer.

657 is a tree.

659 is an obstruction.

FIG. 6F Glyph symbols in section view.

661 is a window.

663 is a wall.

665 is a light shelf.

667 is a window.

FIG. 6G Glyph symbols in section view.

669 is a roof.

671 is a dropped ceiling.

673 is a grade line.

675 is a floor line.

677 is a stroke drawn for a dormer.

679 is a point at the top of the dormer.

681 is a point at the bottom of the dormer.

686 is area of the roof in which the dormer will be inserted.

685 is the top of the dormer.

687 is a window in the dormer.

686 is the interior space of the dormer.

688 the stroke drawn for a skylight.

689 is one endpoint of the skylight.

691 is another endpoint of the skylight.

699 is the area of the roof in which the skylight will be inserted.

693 is the roof.

695 is one side of the skylight.

697 is the window in the skylight.

699 is the space beneath the skylight.

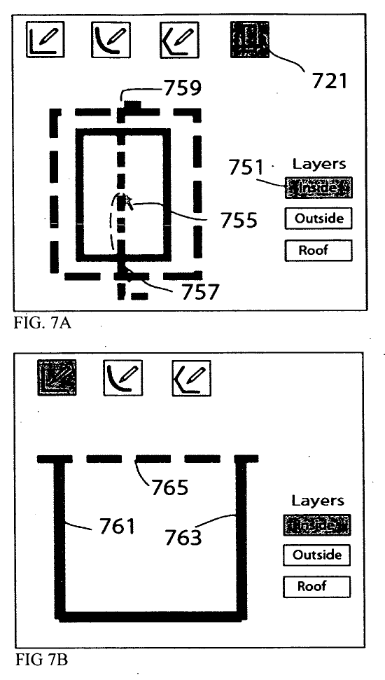

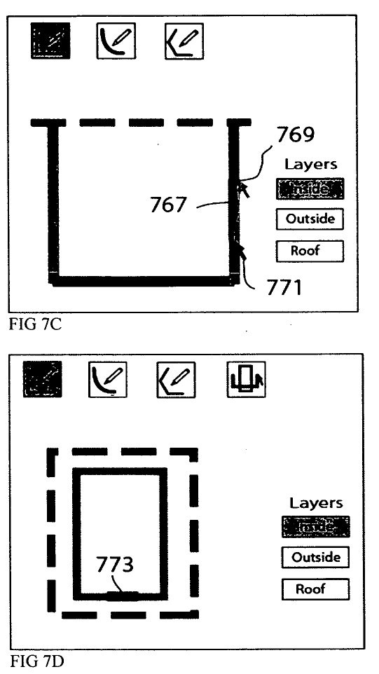

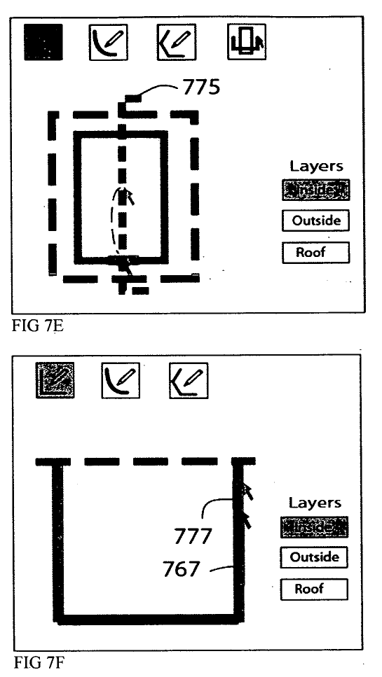

FIG. 7A illustrates the process of drawing windows in section view. First the user begins in plan view and uses the section tool 721 to create a section cut 759 with the motion from 755 to 757. Note the active context is the Inside layer, 751.

FIG. 7B: The section view shows the north wall 761, the south wall 763 and the roof 765.

FIG. 7C: The user draws a window 767 with a stroke from 769 to 771.

FIG. 7D: The user switches back to the plan view to see the window 773 located in the south wall.

FIG. 7E: If the user would like to draw another window above the window 773 on the south wall, he selects the section tool again and section cut 775.

FIG. 7F: The user switches back to the section view and draws a stroke above window 767. This is recognized as a new window 777.

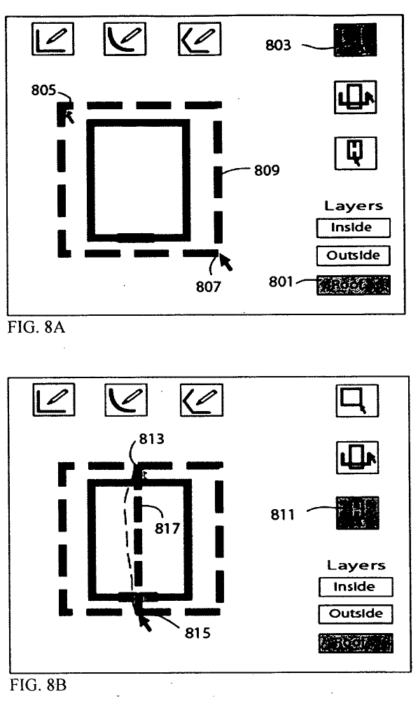

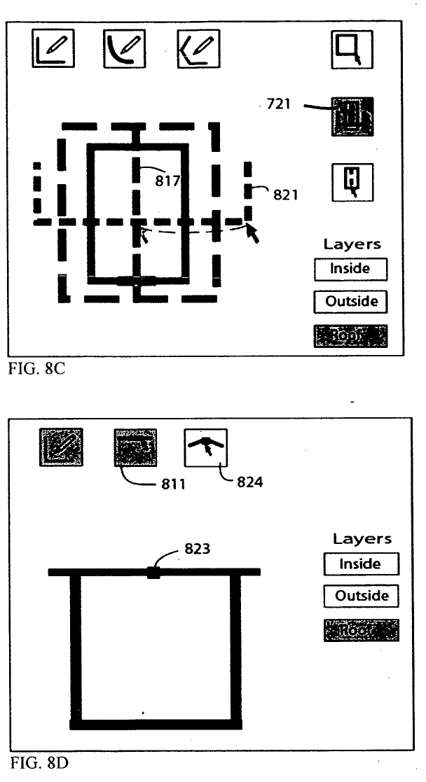

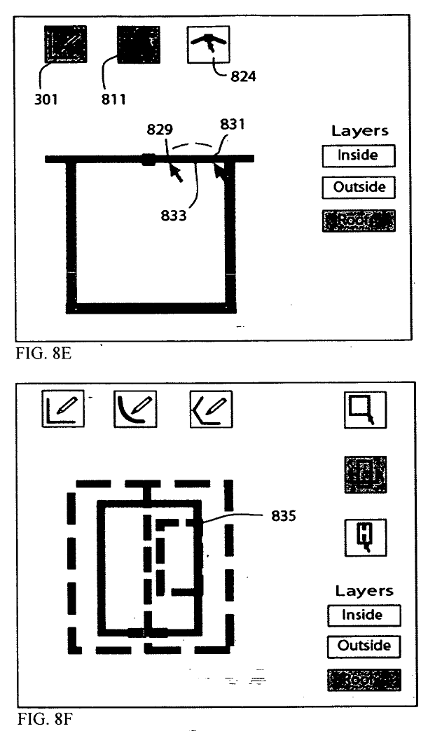

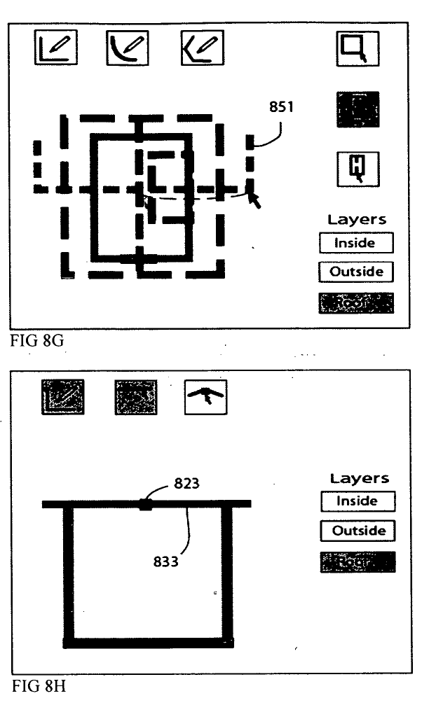

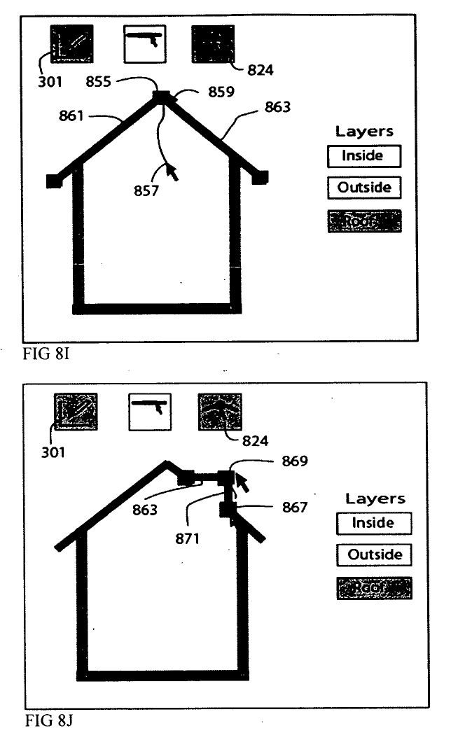

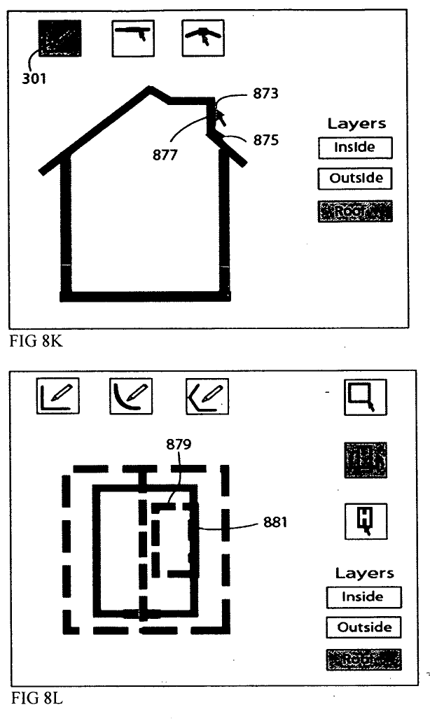

FIG. 8A: FIG. 8 shows the steps in creating, modifying, and adding to a roof using both the plan and section views. In summary, the user wishes to create a gable roof, and add a dormer. To begin, the user selects the Roof layer 801. The glyph for a roof is any closed polygon in plan within the Roof layer. Here, a rectangular roof is desired. To simplify the task of drawing the four sides of a rectangle, the user selects the rectangle tool 803. The rectangle is drawn by clicking at point 805 and dragging to point 807, identifying two diagonally opposing corners. This is recognized as a roof 809.

FIG. 8B: In order to convert this roof into a gable roof, the user uses the ridge tool 811. A ridge is added to the roof by drawing a stroke from 813 to 815. This creates two polygons along with the invariant. The two polygons are joined at the “ridge” 817.

FIG. 8C: In order to represent a ridge 817 in section to form the gable, the user switches to the section view 721 by creating section cut 821 across the ridge 817.

FIG. 8D: In section view, the ridge can now be seen as point 823, which later can be modified (raised) in order to complete the gable, using the ridge tool 811.

FIG. 8E: Before raising the roof, the user can begin drawing a dormer. First, the user uses the ridge tool 811 to identify the location of the future dormer. He locates the dormer from point 829 to 831. This region is recognized and colored red as a visual cue. Notice that the ortho pen 301 is used in conjunction to ensure that the drawn stroke is straight and horizontal.

FIG. 8F: Switching back to the plan view, the user can see how the dormer 835 is located in plan. The length of the stroke is used to determine the length of the dormer, but the width of the dormer is inferred by the system.

FIG. 8G: The user is satisfied with this system-chosen value and switches back to the section view with section cut 851.

FIG. 8H: In section view, the user sees the dormer 833 and the ridge 823.

FIG. 8I: The user uses begins making the gable by lifting the ridge. This is done using the drag tool 824, which moves or resizes part (or all) of an object. First, the roof 861 is selected. Grips or handles such as 855 appear. The user then drags from the original position 857 to 859, pitching the roof 855. Notice that the invariant described earlier (the two sides of the roof must remain joined) is held. Furthermore, there is an invariant that the region set aside as 863 must remain fixed to the roof. This invariant is also respected. As a side note, the ortho pen 301 is used in conjunction with the drag tool 824, to ensure that the dragged point moves straight up.

FIG. 8J: Now the user will address the dormer. The dormer is formed by making a horizontal top, and sides all around. Since the region 863 must remain attached to the roof in some way, pulling it up and away from the roof will automatically create new sides. First, the region is selected, and the handle originally at point 867 is lifted to point 869. A new side 871 is created to respect the invariant. Other sides are also created, but are outside of this section view, namely a side in the foreground and one in the background. Note, the ortho pen 301 and dragging tool 824 are used.

FIG. 8K: To complete the dormer, a window needs to be added. This is done by using the glyph. A window is recognized as a line contained within another line representing a solid such as a wall or roof. The user draws a line from 873 to 875, and the window 877 is recognized.

FIG. 8L: To confirm these changes in plan, the user switches back to the plan view. The user can see that the width of window 877 (in section view), seen as 881 in plan view, is automatically dimensioned by the system. Note, the vertical dimension of the dormer 879 are not visible in plan view, but has already been confirmed in section view.

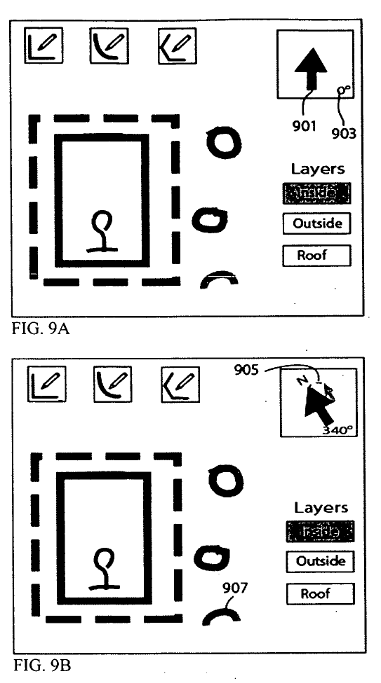

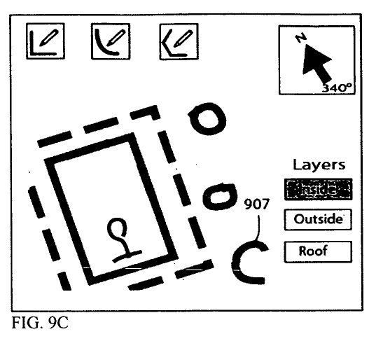

FIG. 9A shows a building on a site with trees. In order to orient with cardinal directions, the user can select the north arrow 901. Note that the degree is also displayed, in this case 0 degrees.

FIG. 9B: To more accurately reflect the site configuration, the user rotates the north arrow widget with a mouse dragging motion 905.

FIG. 9C illustrates the correct orientation of the building and north arrow. The user can continue adding to and editing the building in the more convenient view. However, if a simulation is requested, the entire model's coordinate system, including trees such as 907, is translated immediately before and after simulation.

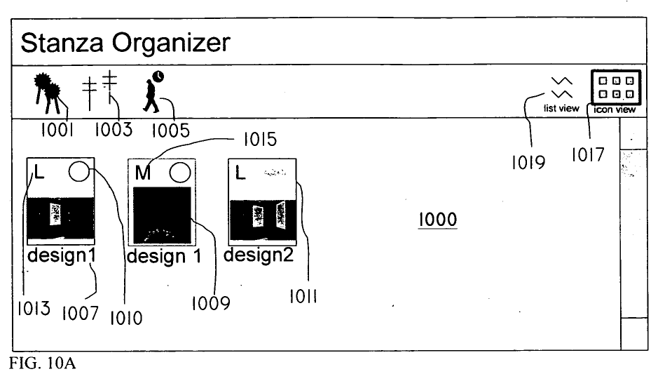

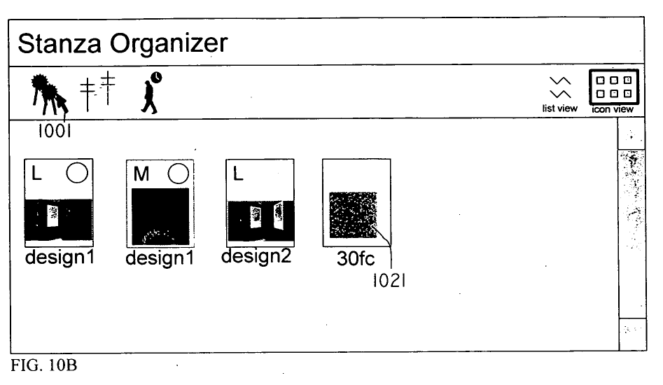

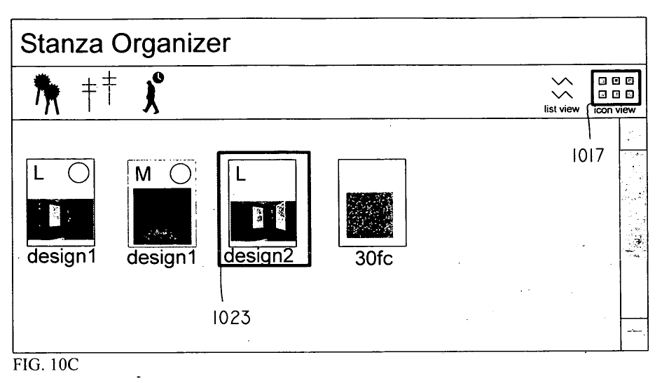

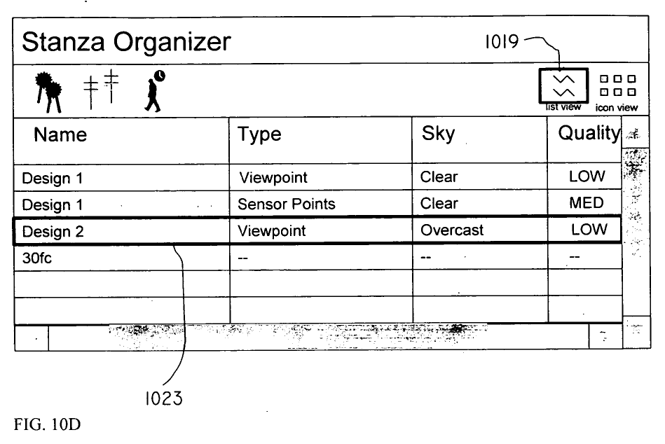

FIG. 10A illustrates the Stanza Organizer.

1000 this is the main organizer window which holds stanzas like a graphical file system.

1001 is a tool that gives quantitative requirements.

1003 is a tool that gives electricity rates.

1005 is a tool that gives the occupancy schedule.

1007 illustrates a perspective of the space of design 1.

1013 indicates a low quality simulation.

1010 indicates clear sky.

1009 is a design option showing an illuminance standard.

1015 indicates a medium quality simulation.

1011 illustrates the perspective of the space of design 2 (overcast sky)

1019 gives the list view.

1017 gives the icon view.

FIG. 10B illustrates the Stanza Organizer

1001 is a tool that gives quantitative requirements.

1021 is a uniform lighting standard, showing a 30 footcandle requirement.

FIG. 10C illustrates the Stanza Organizer

1023 shows that design 2 is selected.

1017 shows the current stanza is in icon view.

FIG. 10D illustrates the Stanza Organizer

1023 shows that design 2 is selected.

1019 shows the current stanza is in list view.

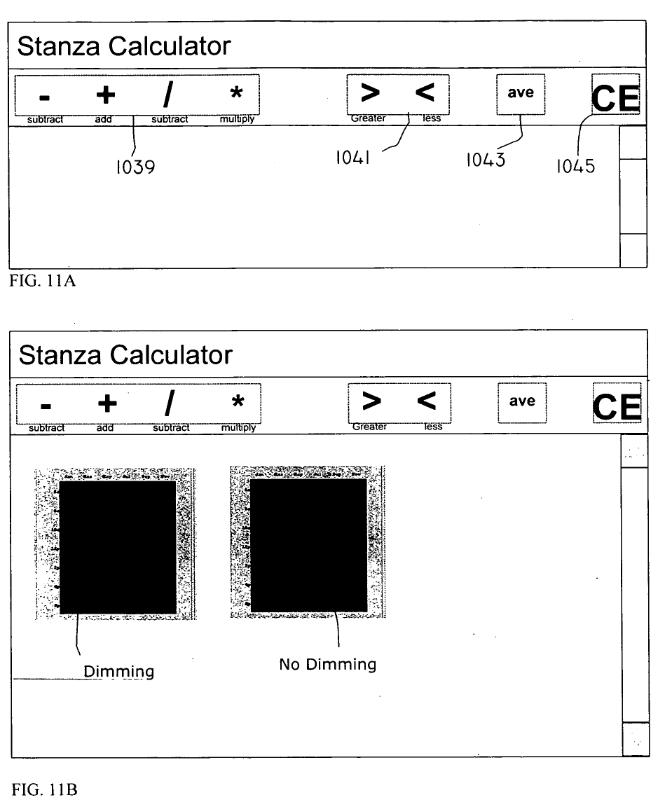

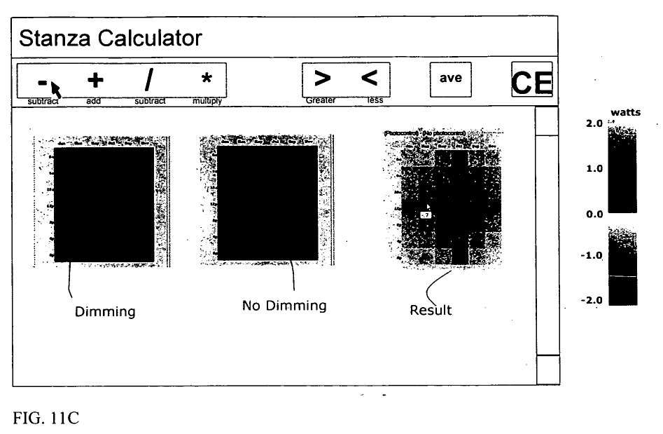

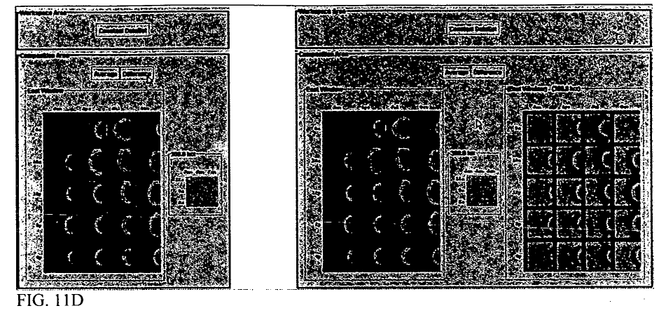

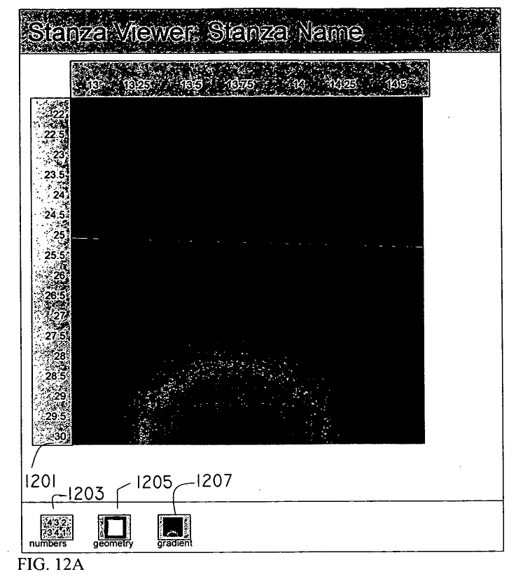

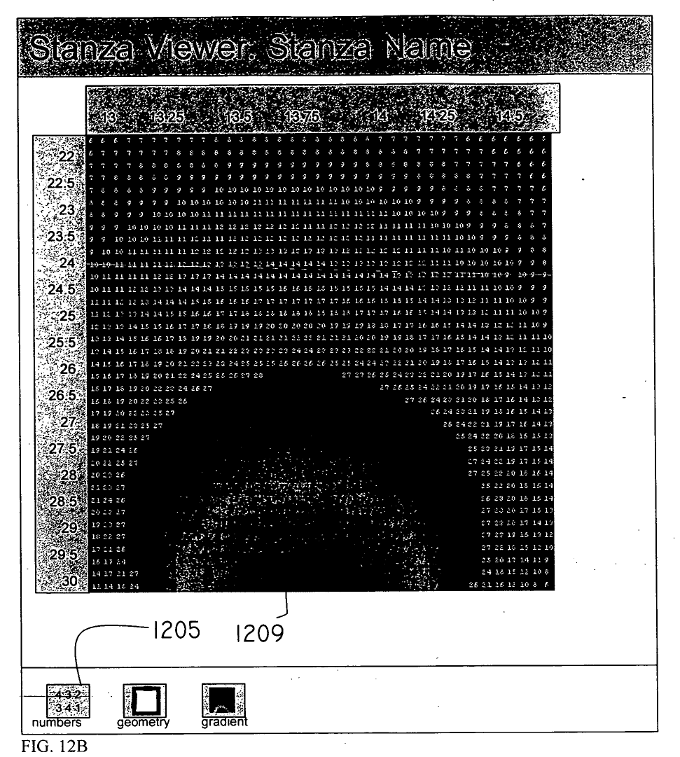

FIG. 11A illustrates the Stanza Calculator.

1039 shows that it can handle arithmetic operations between stanzas. This is important to compare 2 stanzas and other functions.

1041 shows that it can handle Boolean operations between stanzas. This is useful to see if a stanza meets a requirement.

1043 shows that it can manage statistical operations.

1045 is a clear button to put the stanzas back on the organizer.

FIG. 11B illustrates 2 stanzas displaying watt usage information. This information was obtained by drawing 2 lighting systems. The no-dimming system consisted of only electric lights. The dimming system consisted of electric lights, windows and a photo sensor.

FIG. 11C illustrates how the calculator computes the difference between 2 stanzas. Since the left hand quantity (dimming) is less than the right hand quantity (no dimming) in figure 11B than the result is negative. As such, the color map defines this value as shades of blue.

FIG. 11D illustrates how a stanza is colored according to its underlying numeric values.

FIG. 11E illustrates a stanza displaying 2D spatial values at different times of year. Two spatial plots (workplane views) are highlighted, February at 3 pm and November at 9 am. This shows the basic technique for displaying multivariate data.

FIG. 11F illustrates a stanza displaying 2D temporal values at different times of year. Two temporal plots (calendars) are highlighted, at about points (14, 5) and (14, 16) in the space.

FIG. 11G shows a method for transforming FIG. 11E to FIG. 11F. Namely it shows how these views show the same data, but with a different visual representation.

FIG. 11H illustrates one implementation of the calculation engine. It illustrates how two equivalent sized datasets can be compared with the subtraction operator.

FIG. 11I illustrates how the calculation engine can work with two different sized datasets.

FIG. 11J shows a method for how a new stanza can be created from stanzas of unequal size such as in FIG. 11 I.

FIG. 11K illustrates how statistical functions can be managed in this framework.

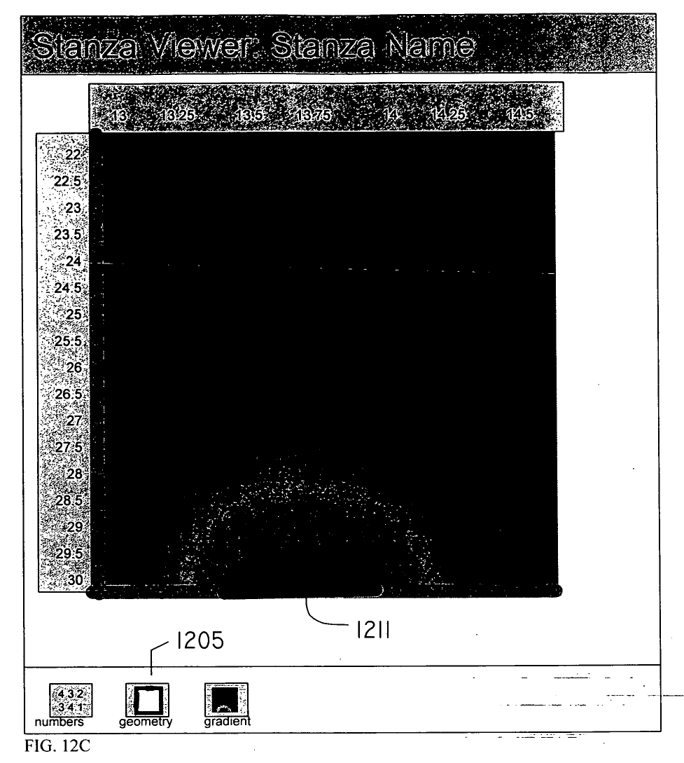

FIG. 12A-C illustrates the stanza viewer. It shows that a stanza can be enlarged and investigated with various viewing options.

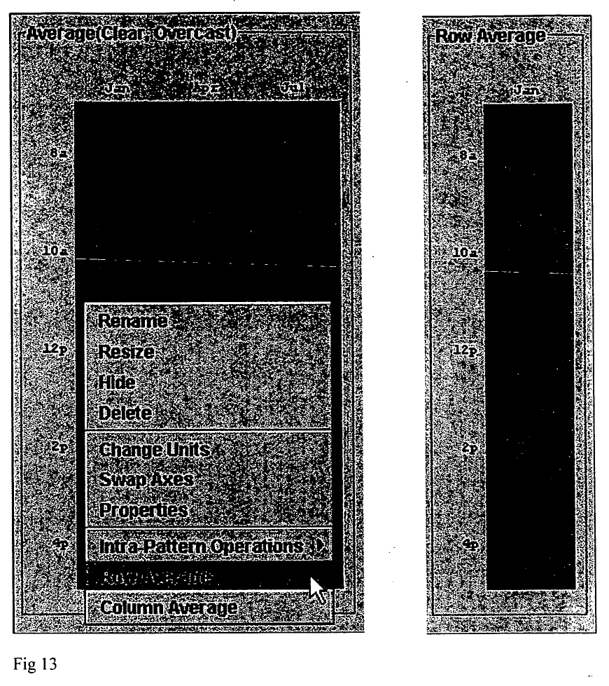

FIG. 13 illustrates an interface for simplifying stanzas by rows, columns or into single values. It uses methods described in FIG. 11K

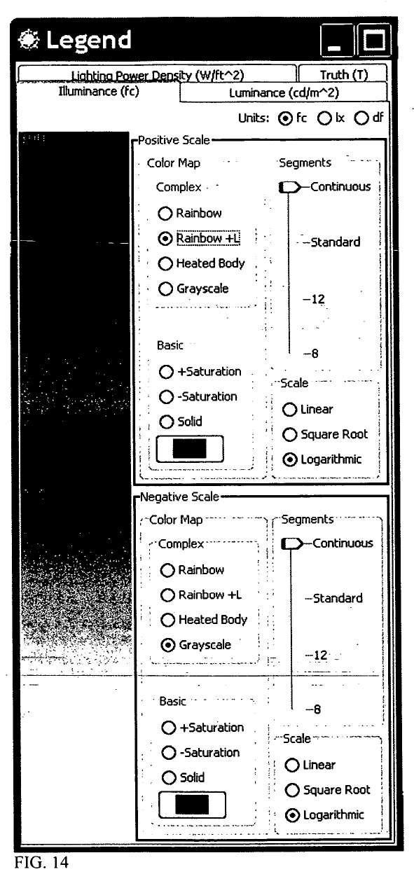

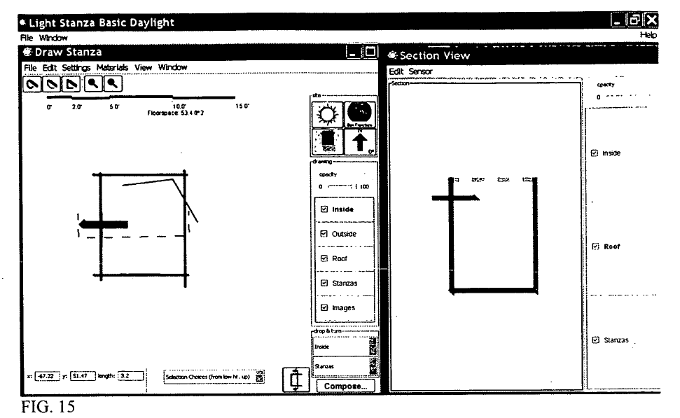

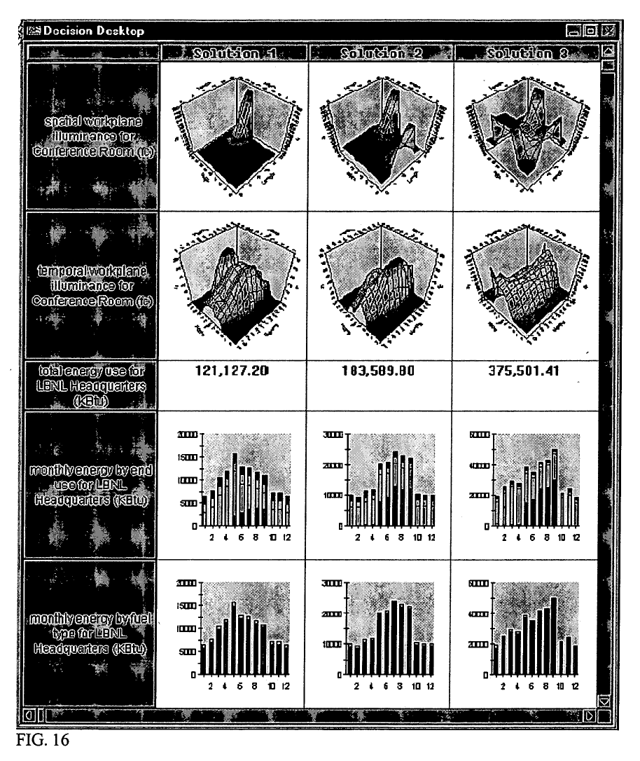

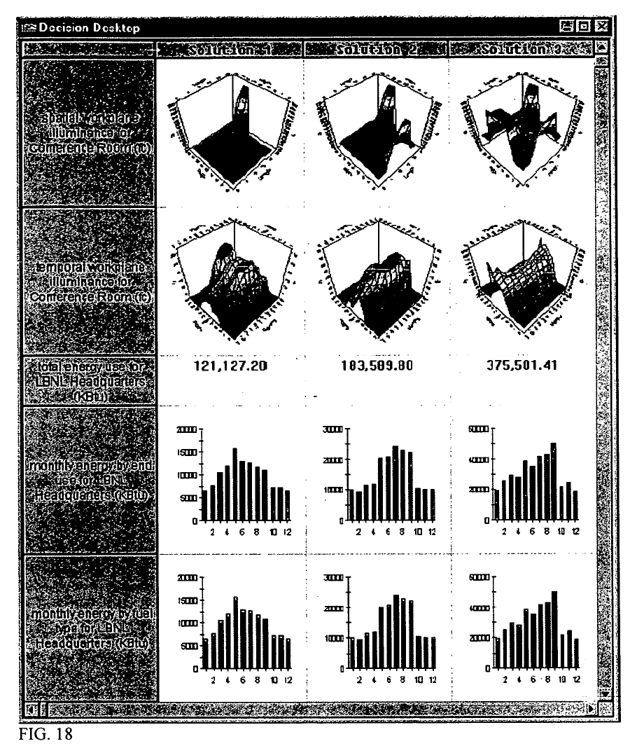

FIG. 14 is a colormap used to represent stanza data. Unique colormaps per datatypes 1419. Also, different maps for positive and negative values.

FIG. 15 is a screen capture showing plan and section view

FIG. 16 is a Building Design Advisor screen shot.

Although the present invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

What is claimed is:

1. A method of optimizing light quality and energy cost using a computer and a software program associated therewith comprising the steps of:
creating a simulated three-dimensional configuration of an indoor environment using the software and plan and section views drawn on and input into the computer, the simulated 3D configuration,
including at least one window adapted to pass external light; and
at least one internal light adapted to create light from energy; and
automatically estimating, using the software, light quality and energy cost within the indoor environment based upon external light characteristics associated with the external light and internal light characteristics associated with the internal light.
